(19) United States
(12) Patent Application Publication
(10) Pub. No.: US 2026/0014604 A1
(43) Pub. Date: Jan. 15, 2026

(54) METHOD FOR DISMANTLING A LITHIUM BATTERY

(71) Applicant: TES SUSTAINABLE BATTERY SOLUTIONS FRANCE, Domene (FR)

(72) Inventors: Farouk TEDJAR, Grenoble (FR); Stéphane TOCCHINI, Domene (FR)

(73) Assignee: TES SUSTAINABLE BATTERY SOLUTIONS FRANCE, Domene (FR)

(21) Appl. No.: 18/993,915

(22) PCT Filed: Jun. 18, 2023
(86) PCT No.: PCT/EP2023/066341

§ 371 Date: Jan. 13, 2025

(30) Foreign Application Priority Data
Jul. 12, 2022 (FR) FR2207133

(51) Int. Cl. B09B 3/35; B09B 3/70; B09B 101/16; B24C 1/04; B26F 3/00; H01M 10/54

(52) U.S. Cl. CPC B09B 3/35; B09B 3/70; B24C 1/045; B26F 3/004; H01M 10/54; B09B 2101/16

(57) ABSTRACT

A method for dismantling a lithium battery includes: providing a lithium battery; cutting the lithium battery by means of a jet of cutting liquid under pressure, the cutting liquid including at least one component that is in liquid state, the cutting liquid being devoid of water, separating constituents of the cut battery and the cutting liquid. The component includes a first component in liquid state to cut the lithium battery, for example carbon dioxide. The component can include at least a second component chosen from ethylene glycol, propylene glycol or a mixture of the latter.

### BACKGROUND OF THE INVENTION

The invention relates to a method for dismantling a lithium battery.

### PRIOR ART

The electric mobility market is booming resulting in a staggering increase in the number of batteries in use. The number of batteries in use is going to rise with the large increase of the automobile vehicle fleet in the forthcoming years. It is apparent that recycling of the batteries will become a major issue from both an environmental and an economic point of view.

When the battery presents a state that is compatible with its reuse, the latter will be able to be reinserted in a new cycle of use. On the other hand, when the battery is in a state that is incompatible with its reuse, the battery will have to be recycled, i.e. to be dismantled in order to dissociate the different constituents of the battery.

Many different methods are known for recycling batteries and in particular for recycling low-capacity lithium-ion batteries such as those used to supply a mobile phone, a laptop or a portable electric tool. Among the numerous methods designed for recycling batteries, the documents U.S. Pat. No. 7,820,317 and EP1,733,451 illustrate methods used in industrial manner in battery recycling.

The higher the electric charge remaining in the battery, the greater the risks. To be able to work in safety, it is important to test the battery electrically and individually before recycling the latter. However, when the battery is defective, it is not always easy to perform electrical testing. The higher the capacity of the battery, the greater the risks related to recycling, as the quantity of stored electric charge may be large and the quantity of lithium is increased.

In conventional manner, recycling of a battery requires access to be had to the internal components, which means that the battery has to be dismantled. Automobile batteries weigh between 180 and 400 kg and each manufacturer has his own integration system. Certain batteries are assembled with nuts and bolts, whereas other batteries are welded or bonded. On account of the very great inhomogeneity in the design and form of the batteries, it is very difficult or even impossible to devise and implement an automated strategy for dismantling the latter. Furthermore, in case of accident, the battery may be deformed which makes it impossible or difficult to dismantle.

Recourse then has to be had to mechanical manual dismantling that is a risky operation as a large quantity of lithium is involved with an electric charge that may be non-negligible. This risk is all the greater due to the fact that, when opening the battery, unintentional piercing of the battery may occur with emission of solvents and/or fluorinated compounds.

### OBJECT OF THE INVENTION

One object of the invention consists in providing a method for dismantling a lithium battery that is simple to implement and that reduces the risks involved in the opening operations of the battery.

According to one feature of the invention, a method for dismantling a lithium battery is proposed comprising the following steps:
providing a lithium battery;
cutting the lithium battery by means of a jet of cutting liquid under pressure, the cutting liquid comprising at least one component that is in liquid state, the cutting liquid not containing water;
separating constituents of the cut battery and the cutting liquid.

Advantageously, the component comprises at least a first component in liquid state to cut the lithium battery, the at least a first component being formed by at least one molecule that is in gaseous state when the at least one molecule is at a temperature equal to 20° C. and at a pressure equal to 1013 hPa, and the method further comprises transformation of the first component from liquid state to gaseous state before separating the constituents of the cut battery and the cutting liquid.

According to a preferential embodiment of the invention, the component is constituted solely by the at least a first component.

Preferentially, the at least a first component comprises carbon dioxide.

In an advantageous embodiment, the at least a first component mainly comprises carbon dioxide in volume.

In preferential manner, separation is performed in dry manner.

According to a preferential feature of the invention, after cutting of the lithium battery, the method comprises recovery of the at least a first component in gaseous state and compression of the at least a first component to place the latter in liquid state to perform cutting of a new lithium battery.

In advantageous manner, the battery is inserted in a chamber filled with a first gas. The first component in gaseous state is denser than the first gas.

In a particular configuration, the cutting liquid is devoid of liquid nitrogen.

In an advantageous development, the component comprises at least a second component chosen from ethylene glycol, propylene glycol or a mixture of the latter.

Preferentially, the liquid jet is a liquid jet at a pressure comprised between 200 and 500 MPa.

According to one embodiment, the liquid jet comprises polyetheramines to neutralise an acid of the battery.

In an advantageous development, in addition to the component in liquid state, the cutting liquid comprises abrasive particles chosen from silicon carbide and a copper slag that preferentially has a fayalite base.

Preferentially, a mass ratio between the component in liquid state and the abrasive particles (m_{liquid}/m_{particles}) is comprised between 2 and 4.

In another advantageous development, the lithium battery is a lithium-ion battery.

### BRIEF DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 schematically illustrates a synoptic breakdown of a method for dismantling a lithium battery according to the invention;

FIG. 2 schematically illustrates a cutting chamber provided with a battery and a cutting liquid injection nozzle.

### DESCRIPTION OF THE EMBODIMENTS

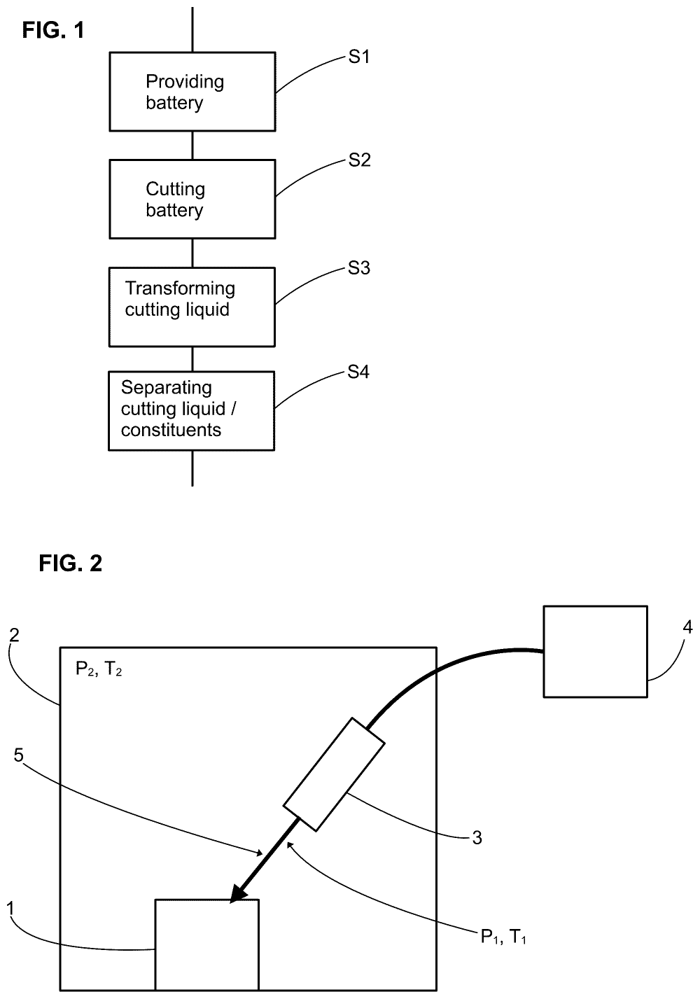

The method for dismantling a lithium battery illustrated in FIG. 1 comprises a first step S1 of providing the lithium battery followed by a cutting step S2 of the lithium battery by means of a liquid jet under pressure. The purpose of cutting step S2 of the lithium battery is to open the lithium battery to gain access to the internal components of the battery to separate the different components. Access to the components of the battery enables for example the lithium to be separated from the other constituents of the battery, for example polymer compounds, noble metals, and iron or steel assembly parts. This also enables solvents to be extracted from the battery.

Following cutting of the battery, the method comprises a step S3 consisting in separating the constituents of the cut battery and the cutting liquid.

As illustrated in FIG. 2, cutting of the battery 1 is performed in a cutting chamber 2. A nozzle 3 is supplied via a tank 4 containing the liquid. High-pressure feeding means are configured to supply the nozzle 3 with liquid at high pressure and to provide a jet 5 of liquid at high pressure able to cut the battery.

Cutting step S2 of the battery uses a liquid jet at high pressure. The liquid comprises at least one component that is in liquid state. Depending on the embodiments, the liquid can contain abrasive particles or be devoid of abrasive particles.

The liquid used for cutting the battery can comprise a single component in liquid state or it can comprise a mixture of several components in liquid state. The liquid is devoid of water. Water is a compound that will react with one or more constituents of the battery. This reaction can be exothermal resulting in risks of burns or explosion. Water can also damage one or more constituents of the battery. It is therefore particularly advantageous not to use water to cut the battery to avoid damaging the different constituents of the battery. Cutting the battery avoids having to use a mechanical manual opening. It is also advantageous to provide for the cutting liquid to be devoid of ionic liquid.

In particularly advantageous manner, the liquid used for cutting the battery only comprises liquid components that do not react with lithium, and in even more preferential manner only liquid components that do not react with the constituents of the battery. The component or components of the cutting liquid are preferentially inert with respect to lithium and even more inert preferentially with respect to the other constituents of the battery.

In a particularly advantageous embodiment, the component comprises at least a first component in liquid state to cut the lithium battery. The at least a first component is formed by at least one molecule that is in gaseous state when the at least one molecule is at a temperature equal to 20° C. and at a pressure equal to 101,325 Pa.

In other words, when the cutting operation is performed, the first component is in liquid state, but the first component can also be in gaseous state under temperature and pressure conditions that are not considered to be detrimental to the constituents of the battery. For example, the first component is chosen to be in gaseous state under standard temperature and pressure conditions (0° C., 101,325 Pa). However, it is advantageous for the first component to be chosen to be in gaseous state at a temperature equal to 20° C. and at a pressure equal to 101,325 Pa which corresponds to working conditions that are not traumatic for an operator.

The use of a component that can easily be in gaseous state makes it easier to recover at least a part of the cutting liquid, after a phase change step S4 of the first component from liquid phase to solid phase.

In an even more advantageous embodiment, the component in liquid phase is constituted solely by the at least a first component. In this way, when the operator performs the battery cutting operation in the chamber to recover the constituents after the cutting operation, the operator can recover elements that are not wetted by the cutting liquid as the latter is completely transformed into gas.

To facilitate separation between the cutting liquid and the battery, the dismantling method comprises transformation of the first liquid component so that the first liquid component changes to gaseous state after cutting of the lithium battery.

The use of a first component that can be in gaseous state under temperature and pressure conditions such that most or all of the constituents of the battery are in liquid state or in solid state facilitates dissociation between the liquid component or the majority liquid component of the cutting liquid that changed phase and the constituents of the battery.

When cutting of the battery takes place, the cutting liquid is ejected from the nozzle under temperature and pressure conditions that ensure that the first component is in liquid state on outlet from the nozzle and that it reaches the battery in liquid state. In preferential manner, the cutting liquid is ejected from the nozzle at high pressure and possibly at low temperature to ensure that it is kept in liquid state. It is advantageous to eject a liquid having a temperature comprised between −56° C. and −80° C. at 1,013 hPa.

In a particular embodiment, cutting of the battery is performed in a chamber under temperature and pressure conditions that correspond to the at least a first component in gaseous state. In this way, the first liquid is ejected from the nozzle in liquid state and strikes the battery in liquid state with sufficient energy to cut the battery. Heating the cutting liquid when performing cutting of the battery enables at least a part of the first component to change to gaseous state. The first component that changed to gaseous state when cutting was performed advantageously remains in gaseous state in the chamber. This configuration means that the thermal and mechanical stresses on the cutting chamber are limited. Depending on the configurations, the first component in liquid state that reaches the walls of the cutting chamber can remain in liquid state or it can change to gaseous state.

In this way, as cutting of the battery takes place, the first liquid component is progressively at least partially transformed into a gas in contact with the battery thereby preferentially partially or totally filling the atmosphere of the chamber with a gas that is inert with respect to the constituents of the battery.

Once the battery has been cut, a transformation step of the first component from liquid state to gaseous state is performed, for example for the portion that was not sufficiently heated when cutting of the battery was performed. Transformation can be achieved with an increase of the temperature and/or a reduction of the pressure in the chamber. In preferential manner, the pressure in the chamber is reduced so as to balance out with the pressure outside the chamber that is preferentially comprised between 90,000 Pa and 110,000 Pa, preferably atmospheric pressure, about 101,325 Pa depending on the altitude and the meteorological conditions. It is also possible to increase the temperature inside the chamber, it being preferable not to exceed 50° C.

In preferential manner, the cutting chamber is filled with a first gas, a pure gas or a gaseous mixture before starting the cutting operation and preferably when the battery is placed in the cutting chamber. It is particularly advantageous for the first component in gaseous state to be denser than the first gas in order to surround the parts of the battery resulting from the cutting operation.

In preferential manner, the at least a first component comprises carbon dioxide. Carbon dioxide does not interact with lithium so that it does not result in degradation of the carbon, for example combustion of the lithium. The interaction of carbon dioxide with the other constituents of the battery is weak or non-existent thereby facilitating recycling of the latter. Preferentially, the at least a first component mainly comprises carbon dioxide in volume, or the at least a first component comprises only carbon dioxide. In an advantageous embodiment, the first component is chosen from carbon dioxide, argon and helium. Carbon dioxide is preferred as it is less expensive.

In preferential manner, the first component is devoid of dinitrogen or of any other molecule able to form liquid nitrogen under the application conditions of the liquid jet. It was observed that nitrogen can form very reactive compounds with lithium particles such as lithium azides (LiN3) and lithium nitrides (Li3N). Lithium azides break down violently during heating of the liquid phases and can give rise to toxic compounds. The same is the case for lithium nitrides.

In preferential manner, after the lithium battery has been cut, the method for dismantling a lithium battery comprises recovery of the at least a first component in gaseous state and compression of the at least a first component to place the latter in liquid state in the tank for a new cutting cycle of a new lithium battery. The material used for performing cutting of the battery is thus transformed into gaseous state to be dissociated from the constituents of the battery and is then compressed to transform to liquid state and be reused for a new battery, thereby reducing the consumption of the first component.

It is particularly advantageous to use a first component that is denser than air, for example carbon dioxide. When transformation from liquid phase to gaseous phase takes place, this enables the constituents of the battery to be bathed in an atmosphere that is less reactive than air with respect to the latter. The carbon dioxide pushes the oxygen and the other gases that are able to react with the lithium towards the top of the chamber, thus reducing the risks of reaction between the lithium and the gases present in the atmosphere of the chamber. This embodiment is particularly advantageous when the atmosphere of the chamber is not replaced before the cutting step, for example when the atmosphere of the chamber is air at the beginning of the cutting operation with a liquid jet. What is meant by “air” is a gaseous mixture containing at least 75% nitrogen and 20% oxygen.

In preferential manner, cutting of the lithium battery is performed in a chamber, the chamber being devoid of oxygen before the cutting operation is begun. In preferential manner, cutting of the lithium battery is performed in a chamber, the chamber being devoid of nitrogen before the cutting operation is begun.

At the end of the cutting step by the liquid jet, the chamber is mainly filled in volume by the first component in gaseous state.

The method for dismantling a lithium battery comprises a step S3 of recovery of the parts of the battery, the parts of the battery being dried after the battery has been cut open. As the first component has been transformed into gaseous state, the constituents of the battery are usable immediately for the next recycling step. When the liquid component only comprises the first component, transformation of the first component from liquid state to gaseous state enables dry sorting of the constituents of the battery to be performed. When the cutting liquid contains abrasive particles, a dry sorting exists between the abrasive particles and the constituents of the battery.

In an advantageous embodiment, the component in liquid state comprises at least a second component that is in liquid state under the standard temperature and pressure conditions and/or at 20° C. and at 101,325 Pa. In preferential manner, the second component has a boiling temperature higher than 120° C., advantageously higher than 150° C. The second component is designed to be mainly or exclusively in liquid state throughout the cutting step and until the constituents of the battery have been recovered.

It is also advantageous to choose a second component that presents a low saturated vapour pressure, for example lower than 50 Pa at 20° C. The second component naturally has a low or even null reactivity with the constituents of the battery.

It is also advantageous to choose a second component that presents an auto-ignition temperature higher than 300° C., more preferentially higher than 350° C.

Depending on the configurations, the component only comprises the first component, the second component or a mix between the first component and the second component. In even more preferential manner, if the battery is cut simultaneously by means of the first component and the second component, the first component is delivered by means of a first nozzle and the second component is delivered by means of a second nozzle.

It is particularly advantageous to choose the second component from alkyl glycol. In an advantageous embodiment, the component comprises at least a second component chosen from ethylene glycol, propylene glycol or a mixture of the latter. These components are particularly attractive as they do not react with lithium or with most of the constituents of the battery. It is then possible to cut the battery without fear of damaging the lithium. The use of alkyl glycol is attractive as it enables the traces of water present in the atmosphere to be reduced thereby reducing the risks of reaction between the traces of water and the lithium salts, thus reducing the risks of formation of hydrofluoric acid.

In advantageous manner, to obtain fast and efficient cutting of the battery and in particular of its outer casing, it is preferable to have a liquid jet pressure that is greater than 5 MPa, more preferentially greater than 15 MPa, even more preferentially greater than 50 MPa. When the component is mainly formed by the first constituent, the liquid jet is preferentially a liquid jet at a pressure comprised between 200 and 500 MPa. It is also possible to use this pressure range for the second component.

In a preferred embodiment, the liquid jet comprises polyetheramines to neutralise an acid of the battery. A possible polyetheramine to neutralise an acid is marketed by the Huntsman International Corporation under the tradename Jeffamine®. The use of a polyetheramine is advantageous in combination with the first and/or second component. The use of polyetheramines is particularly advantageous when the battery comprises lithium hexafluorophosphate salt. It is particularly advantageous to use a polyetheramine that has a saturated vapour pressure of less than 50 Pa at 20° C. and a flash point temperature that is higher than the temperature of the second component, preferentially higher than 110° C. or even higher than 150° C.

The use of polyetheramines is particularly advantageous in association with the second component chosen from alkyl glycol as the properties of polyetheramines do not impair the performances of alkyl glycols.

To increase the cutting power of the liquid jet with respect to the constituents of the battery, preferably with respect to the outer casing of the battery, it is advantageous for the liquid used to form the liquid jet to comprise abrasive particles in addition to the component in liquid state. Advantageously, the abrasive particles are made from a material that does not react chemically with lithium and preferentially that does not react chemically with the other constituents of the battery.

It is particularly advantageous for the abrasive particles to be devoid of steel and/or garnet as these materials can react with lithium. What is meant by garnet is a group of silicates of A3B2(SiO4) 3 type in which A is composed of calcium (Ca), iron (Fe), magnesium (Mg) and manganese (Mn) and B concerns inclusions of aluminium (Al) or chromium (Cr) base. Depending on the origin of the deposits, traces of beryllium (Be), molybdenum (Mo), cobalt (Co), nickel (Ni), zinc (Zn), cadmium (Cd), and arsenic (As) are detected.

In preferential manner, the abrasive particles are chosen from silicon carbide and copper slag and preferentially with a fayalite base.

It is particularly advantageous to use silicon carbide as silicon carbide is very stable in the pH range comprised between 1 and 13 while presenting a high hardness that makes it capable of cutting the battery without being chemically impaired in contact with the different constituents of the battery. Silicon carbide can be used in a form that crystallises in a hexagonal system or in its β form that crystallises in a face-centred cubic system. These two forms are stable in the above-mentioned temperature range. It is also apparent that these two forms are chemically stable in a −100° C. to +1,000° C. temperature range. Silicon carbide presents fine qualities to form abrasive particles in a liquid jet cutting operation.

The abrasive particles can also be particles originating from a copper slag. Copper slag particles originate from smelting of the copper mineral. The particles comprise a mass fraction of iron oxide Fe2O3 greater than 40%, a mass fraction of silicon oxide SiO2 greater than 30%, a mass fraction of aluminium oxide A12O3 less than 10% and a mass fraction of calcium oxide less than 10%, preferably less than 5%.

It is particularly advantageous for the abrasive particles to comprise copper trapped in the form of a sulfide in an amorphous vitreous matrix. This enables the copper not to leach in a soluble ionic form.

In advantageous manner, the abrasive particles comprise olivine particles and more preferentially fayalite particles, i.e. particles of Fe2SiO4. Even more preferentially, the abrasive particles comprise particles of (Mg, Fe)2SiO4 type.

Like silicon carbide particles, copper slag particles have a high chemical stability over a pH range comprised between 2 and 12 and a good thermal stability between −100° C. and +1,000° C.

In an advantageous embodiment, a mass ratio between the component and the abrasive particles (m_{liquid}/m_{particles}) is comprised between 2 and 4 when cutting of the battery is performed by the liquid.

The method for dismantling a lithium battery is particularly advantageous when the lithium battery is a lithium-ion battery.

The method for dismantling a lithium battery is particularly advantageous when the lithium battery is a battery of an electric vehicle, for example an electric motor car.

1-15. (canceled)

16. A method for dismantling a lithium battery comprising the following steps:
providing a lithium battery;
cutting the lithium battery by means of a jet of a cutting liquid under pressure, the cutting liquid comprising at least one component that is in liquid state with at least a first component in liquid state, the cutting liquid being devoid of water;
transforming the at least a first component from liquid state to gaseous state before separating constituents of the cut battery and the cutting liquid.

17. The method for dismantling a lithium battery according to claim 16 wherein the at least a first component is formed by at least one molecule that is in gaseous state when the at least one molecule is at a temperature equal to 20° C. and at a pressure equal to 1013 hPa.

18. The method for dismantling a lithium battery according to claim 17 wherein the component is constituted solely by the at least a first component.

19. The method for dismantling a lithium battery according to claim 17 wherein the at least a first component comprises carbon dioxide.

20. The method for dismantling a lithium battery according to claim 19 wherein the at least a first component mainly comprises carbon dioxide in volume.

21. The method for dismantling a lithium battery according to claim 16 wherein separating is performed in dry manner.

22. The method for dismantling a lithium battery according to claim 21 comprising, after cutting the lithium battery, recovering the at least a first component in gaseous state and compressing the at least a first component to place the at least a first component in liquid state to perform cutting of a new lithium battery

23. The method for dismantling a lithium battery according to claim 17 wherein the battery is inserted in a chamber filled with a first gas and wherein the at least a first component in gaseous state is denser than the first gas.

24. The method for dismantling a lithium battery according to claim 16 wherein the cutting liquid is devoid of liquid nitrogen.

25. The method for dismantling a lithium battery according to claim 16 wherein the at least one component comprises at least a second component chosen from ethylene glycol, propylene glycol or a mixture of ethylene glycol and propylene glycol.

26. The method for dismantling a lithium battery according to claim 16 wherein the liquid jet is a liquid jet at a pressure comprised between 200 and 500 MPa.

27. The method for dismantling a lithium battery according to claim 16 wherein the liquid jet comprises polyetheramines to neutralise an acid of the battery.

28. The method for dismantling a lithium battery according to claim 16 wherein, in addition to the at least one component in liquid state, the cutting liquid comprises abrasive particles chosen from silicon carbide and a copper slag.

29. The method for dismantling a lithium battery according to claim 28 wherein a mass ratio between the at least one component in liquid state and the abrasive particles (m_{liquid}/m_{particles}) is comprised between 2 and 4.

30. The method for dismantling a lithium battery according to claim 28 wherein the copper slag has a fayalite base

31. The method for dismantling a lithium battery according to claim 16 wherein the lithium battery is a lithium-ion battery.
